(19) United States
(12) Patent Application Publication
(10) Pub. No.: US 2018/0260255 A1
(43) Pub. Date: Sep. 13, 2018

(54) LOCK-FREE REFERENCE COUNTING

(71) Applicant: Futurewei Technologies, Inc., Plano, TX (US)

(72) Inventors: Reza Yazdani, Los Altos, CA (US); Haichuan Wang, San Jose, CA (US); Lin Ma, San Jose, CA (US)

(73) Assignee: Futurewei Technologies, Inc., Plano, TX (US)

(21) Appl. No.: 15/456,140

(22) Filed: Mar. 10, 2017

(51) Int. Cl. G06F 9/52; G06F 17/30

(52) U.S. Cl. CPC G06F 9/52; G06F 17/30377; G06F 17/30327

(57) ABSTRACT

The disclosure relates to technology for reference counting. A parent thread counter corresponding to an object is created by a parent thread, where the parent thread counter includes a hierarchical counter data structure. A child thread counter of a child thread is created that includes the hierarchical counter data structure and passes the reference to the object from the parent thread to the child thread. The hierarchical counter data structure is updated in the parent thread counter to reference the child thread counter and in the child thread counter to point to the parent thread counter. The parent thread counter is then when the child thread has completed processing. As part of the updating, the parent and child thread counters employ a lock-free mechanism.

### BACKGROUND

Memory management systems typically keep track of memory objects after they are created and delete those objects when they are no longer needed so that the memory being used becomes available again. These systems, also known as garbage collectors, often work by maintaining a reference count that is associated with each memory object. For example, a reference count is used to keep track of objects being created or allocated, and subsequently removed, in memory. The reference count is incremented when a thread (or process or other entity) accesses or otherwise references that memory object. The reference count is decremented when the thread dereferences the memory object. When the reference count reaches zero, the memory object is assumed to no longer be in use and the memory manager may free the memory for re-use to thereby reduce the possibility of running out of memory.

Additionally, computing systems often have multiple processors over which a given workload may be distributed to increase computational throughput. Each processor may have an associated memory that operates at a higher speed than the main memory. When multiple threads are executing on different processors and accessing, or sharing, a common memory object, the reference count for that object will typically need to be transferred from one memory to another, which may result in increased latencies and reduced processing efficiency. As the computing system increases in size with a greater number of threads executing in parallel, the memory management may result in an increased number of reference counting instructions being issued, along with a decrease in overall system performance.

### BRIEF SUMMARY

In a first embodiment, there is a computer-implemented method for reference counting, comprising creating a parent thread counter corresponding to an object referenced by a parent thread, the parent thread counter comprising a hierarchical counter data structure; creating a child thread counter of a child thread including the hierarchical counter data structure and passing the reference to the object from the parent thread to the child thread; updating the hierarchical counter data structure in the parent thread counter to reference the child thread counter and in the child thread counter to point to the parent thread counter; and notifying the parent thread counter when the child thread has completed processing.

In a second embodiment according to any of the preceding embodiments, creating the parent thread counter includes initializing the hierarchical counter data structure to set a parent count value to an initial value of 1, a state of the parent thread to active, a list of children to empty and a pointer to empty, and creating the child thread counter includes initializing the hierarchical counter data structure to set a child count value to an initial value of 1, a state of the parent thread to active, a list of children to empty and a pointer to the parent thread counter.

In a third embodiment according to any of the preceding embodiments, updating the hierarchical counter data structure comprises increasing the parent count value of the parent thread counter when the parent thread adds a reference to the object and decreasing the parent count value of the parent thread counter when the parent thread removes the reference to the object; and increasing the child count value of the child reference counter when the child thread adds a reference to the object and decreasing the child count value of the child reference counter when the child thread removes the reference to the object.

In a fourth embodiment according to any of the preceding embodiments, the computer-implemented method further comprising changing the state of the parent thread and the child thread from active to inactive upon completion of processing; independently modifying the list of children in the parent thread and the child thread to add or remove children counters; and setting the pointer for newly added children to point to a direct parent counter.

In a fifth embodiment according to any any of the preceding embodiments, removing the reference to the object comprises determining whether the child thread counter has completed processing based on the child count value; checking the child thread counter for the list of children; and in response to the child count value of the child thread counter being zero, the list of children of the child thread counter being empty or all of the child threads listed in the list of children for the child thread being inactive and the state of the child thread being inactive, removing the reference to the object.

In a sixth embodiment according to any of the preceding embodiments, the computer-implemented method further comprising determining whether the parent thread counter has completed processing based on the parent count value; checking the pointer in the parent thread; and releasing the object from the memory in response to the pointer being empty and the state of the parent thread being inactive.

In a seventh embodiment according to any of the preceding embodiments, the hierarchical counter data structure includes a count value to count a number of references to the object, a variable indicating a state of the object as active or inactive, a list of child counters and a pointer to point to a parent counter.

In an eighth embodiment according to any of the preceding embodiments, the count value indicating the number of references to the object is independently modified by one of the parent thread and the child thread; the state is changed from an active state to an inactive state; the list of child counters identifies individual children counters for a corresponding one of the threads; and the pointer is set when initially creating one of the thread counters.

In a ninth embodiment according to any of the preceding embodiments, the parent thread counter and the child thread counter employ a lock-free reference count.

In a tenth embodiment, there is a device for reference counting, comprising a non-transitory memory storage comprising instructions; and one or more processors in communication with the memory, wherein the one or more processors execute the instructions to perform operations comprising: creating a parent thread counter corresponding to an object referenced by a parent thread, the parent thread counter comprising a hierarchical counter data structure; creating a child thread counter of a child thread including the hierarchical counter data structure and passing the reference to the object from the parent thread to the child thread; updating the hierarchical counter data structure, without locking, in the parent thread counter to reference the child thread counter and in the child thread counter to point to the parent thread counter; and notifying the parent thread counter when the child thread has completed processing.

In an eleventh embodiment, there is a non-transitory computer-readable medium storing computer instructions for reference counting, that when executed by one or more processors, perform the steps of creating a parent thread counter corresponding to an object referenced by a parent thread, the parent thread counter comprising a hierarchical counter data structure; creating a child thread counter of a child thread including the hierarchical counter data structure and passing the reference to the object from the parent thread to the child thread; updating the hierarchical counter data structure in the parent thread counter to reference the child thread counter and in the child thread counter to point to the parent thread counter; and notifying the parent thread counter when the child thread has completed processing.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

Aspects of the present disclosure are illustrated by way of example and are not limited by the accompanying figures for which like references indicate elements.

FIG. 1 illustrates an example of a distributed data system according to one embodiment.

FIGS. 2A and 2B illustrate an example of threads referencing data in a memory management system in accordance with conventional methods.

FIG. 3A illustrates an example overview of two threads of a process referencing data stored in memory.

FIG. 3B illustrates a hierarchical counter data structure for a counter in accordance with FIG. 3A.

FIG. 3C illustrates an example call flow that implements the hierarchical counter data structure of FIG. 3B.

FIG. 3D illustrates an example of a multithreaded process in which parent thread and child thread reference data allocated in memory.

FIGS. 4A-4B illustrate flow diagrams of reference counting in accordance with the embodiments disclosed in FIGS. 1 and 3A-3D.

FIG. 5 illustrates one embodiment of a flow diagram for a local thread counter in accordance with FIGS. 3A-3B, 3D and 4A-4B.

FIG. 6 illustrates a block diagram of a network system that can be used to implement various embodiments.

### DETAILED DESCRIPTION

The disclosure relates to technology for memory management using reference counters.

Reference counters have long been used in memory management to track the number of threads referencing (pointing to) data (an object) stored in memory. As described above, as the number of threads in a computing system increase, the memory management may result in an increased number of reference counting instructions being issued (increased overhead), along with a decrease in overall system performance.

To ensure that an object being referenced by one thread is not accessed by another thread at the same time, a locking mechanism (e.g., a semaphore) is often introduced to prevent access to the referenced object. When an object is referenced, the locking mechanism is implemented by an instruction from the system. With each instruction to lock a referenced object, additional overhead is introduced into the system.

In one embodiment, to reduce overall number of instructions and increase system performance, a parent thread counter and a child thread counter is introduced. Each of the thread counters is associated with one or more threads and tracks the number of references being made to the object by the associated thread. Additionally, each of the thread counters includes a hierarchical counter data structure that promotes the updating of the counter using member elements to monitor the overall status of a particular thread.

In one embodiment, the thread counters are implemented without a lock. That is, updating the values of the hierarchical counter data structure of the thread counters does not require the thread counter to be locked in order for the update to occur.

It is understood that the present embodiments of the disclosure may be implemented in many different forms and that claims scopes should not be construed as being limited to the embodiments set forth herein. Rather, these embodiments are provided so that this disclosure will be thorough and complete and will fully convey the inventive embodiment concepts to those skilled in the art. Indeed, the disclosure is intended to cover alternatives, modifications and equivalents of these embodiments, which are included within the scope and spirit of the disclosure as defined by the appended claims. Furthermore, in the following detailed description of the present embodiments of the disclosure, numerous specific details are set forth in order to provide a thorough understanding. However, it will be clear to those of ordinary skill in the art that the present embodiments of the disclosure may be practiced without such specific details.

Various processing languages, such as Python, offer automatic reference counting or garage collection, in which memory is automatically freed when no longer in use. A general method for garbage collection in these types of languages is for the system to periodically perform a check of all objects to determine whether each object is still being referenced by thread or process. If an object is still being referenced, the object remains untouched. If, on the other hand, the object is no longer being referenced (e.g., no thread is currently referencing the object), then the system releases the object. This periodic checking behavior introduces heavy system overhead at unpredictable intervals and is therefore not an ideal solution, especially in performance sensitive environments.

Other processing languages, such as C and C++, do not typically offer automatic garbage collection, but do afford a manual mechanism in which to reference count. In these environments, object release from the memory is explicitly managed by the programmer. Reference counting provides a relatively simple garbage collection mechanism that has a constant incremental overhead. According to such a reference counting mechanism, an indicator (e.g., a counter) of some type is used to determine whether an object is being processed. While reference is being made to the object, the indicator informs the system that the object is being processed and should not be released, whereas no reference being made to the object informs the system that the object is no longer being processed and may be released.

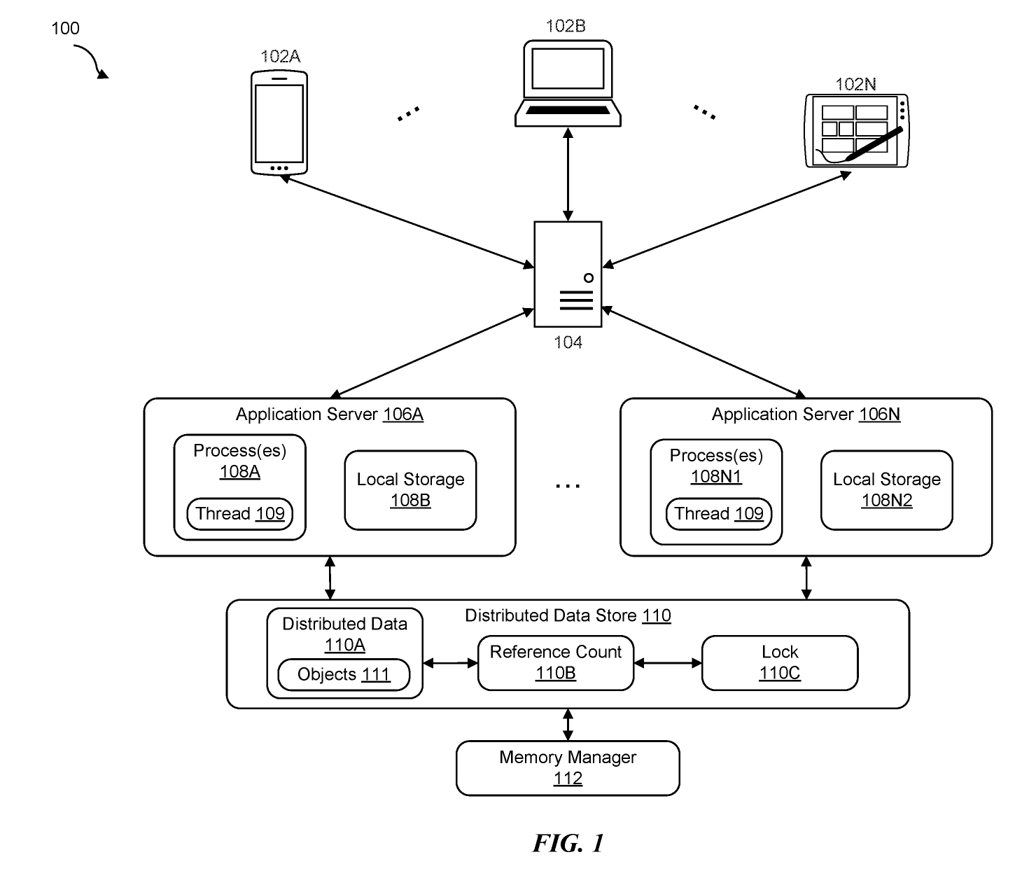

FIG. 1 illustrates an example of a distributed data system according to one embodiment. The distributed data system 100 includes, for example, client devices (or nodes) 102A-102N, server 104, application servers 106A-106N, distributed data store 110 and memory manager 112. In one embodiment, the distributed data system is a memory management system.

Clients 102A-102N may be, but are not limited to, devices such as desktop personal computers, laptops, PDAs, tablets, smartphones, point-of-sale terminals, etc. that may execute client applications, such as web browsers.

The server 104 may include one or more servers, such as an enterprise server (e.g., web server), that provide content to the clients 102A-102N via a network (not shown). The network may be a wired or wireless network or a combination thereof, and may include a LAN, WAN, Internet, or a combination thereof. Any of a variety of one or more networking protocols may be used in the network, for example, TCP/IP.

Application servers 106A-106N, which facilitate creation of web applications and an environment to execute the web applications, may include processes (or applications) 108A-108N1 and local storage 108B-108N2, respectively. In one example, the processes 108A-108N1 may be used by the clients 102A-102N to apply logic to distributed data stored in local storage 108B-108N2, respectively. Processes 108A-108N1 may include one or more threads 109.

Threads 109 (or code modules) execute on the multiple cores of application servers 106A-106N and may be configured to enter a transaction when accessing objects 111 in memory. During the transaction, the threads 109 may perform an access of the reference count 1108 associated with the object 111.

Local storage 108B may, for example, include local instances of data or objects of the distributed data maintained by the application servers 106A-106N, for example, for use by local clients of the application servers 106A-106N or by processes 108A-108N1 executing within the application servers 106A-106N.

Distributed data store 110 includes, for example, data structure 110A, reference count 1108 and lock 110C. The distributed data store 110 may store data including one or more instances of distributed data 110A, where distributed data 110A may include an instance of the distributed data that is accessible by the application servers 106A-106N. In one embodiment, distributed data 110A may be distributed on the distributed data system across one or more computer-accessible mediums. In another embodiment, distributed data store 110 may include storage on one or more computer systems that also host one or more of application servers 106A-106N.

In one embodiment, the processes 108A 108N1 may provide data and/or services to enterprise server 104, for example, for use by the clients 102A-102N. The application servers 106A-106N may send updates of distributed data to distributed data store 110 in response to an event, such as a modification of one or more attributes of the local data in local storages 108A 0 108N, and/or as routine maintenance to synchronize the distributed data with the local data. In one embodiment, an attribute may be a portion or element of the distributed data, and may be one of any of various types of data that may be used in a process such as programming language objects or classes (e.g., Java objects or classes), strings, integers, Booleans, characters, real number representations, or any other type of computer-representable data.

Distributed data store 110 may also include a lock 110C, in which the lock 110C may grant or deny access to processes 108A-108N1 for one or more portions of the distributed data 110A. Thus, when one of the processes 108A-108N1 locks one or more portions of the distributed data 110A, other processes 108A-108N1 may not access that portion. At the same time, however, other processes 108A-108N1 may lock other portions of the distributed data 110A.

In one embodiment, a process 106A-106N may hold one or more locks, with each lock 110C corresponding to one or more portions of distributed data 110A. A thread 109 of a multithreaded process 106A-106N may request a lock 110C for a portion of the distributed data 110A for the processing. In one embodiment, the lock 110C is implemented with a locking mechanism (not shown) that may grant the lock to the thread for processing.

In one embodiment, to access distributed data 110A, one of processes 108A-108N1 executing within an application server 104 may request a lock 110C, such as a mutex, for a portion of distributed data 110A. If another of the processes 108A-108N1 does not currently hold the lock 110C for the same portion of distributed data 110A, the lock 110C may be issued to the requesting process 108A or 108N1. If another process holds the lock 110C for the requested portion of distributed data 110A, the requesting process 108A or 108N1 may enter a wait state or may continue executing another task while waiting for the lock 110C to be released.

Memory manager 112 is configured to track objects in memory after they are created and delete those objects when they are no longer needed so that the memory may be freed for reallocation. This may be accomplished by maintaining a reference count for each object allocated in memory. The reference count is incremented when a thread (code module, process or other entity) accesses or otherwise references the object in memory. The reference count is decremented when the thread no longer references the object in memory. When the reference count reaches zero, or some threshold value, the memory object may be assumed to no longer be in use and the memory manager can delete the object and free the memory associated with that object.

It is appreciated that the above described locking and protection mechanisms are non-limiting examples, and that any number of well-known locking techniques may be employed.

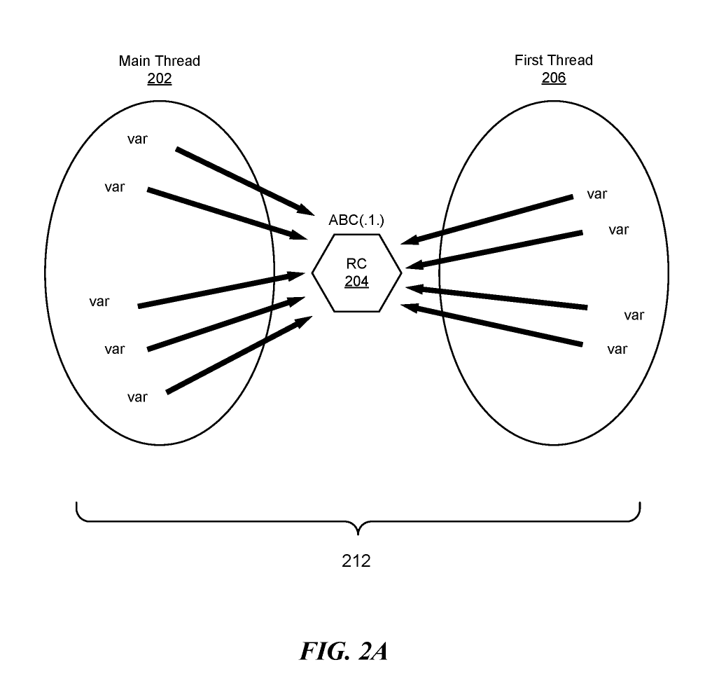

FIGS. 2A and 2B illustrate an example of threads referencing data in a memory management system in accordance with conventional methods. In particular, FIG. 2A depicts an overview of two threads of a process referencing data stored in memory of the memory management system 212. Each of the threads (main thread 202 and first thread 206) have variables that reference (or point to) data that is allocated to a particular space in memory and for which reference counter (RC) 204 tracks the number of references being made. References from a thread variable to the data stored in memory (and the associated reference counter 204) are demonstrated by the darkened arrows.

In one embodiment, the data is an object ABC(.1.) being shared by main thread 202 and first thread 206. In another embodiment, the object ABC(.1.) allocated to memory provides the functionality to maintain a reference count (a count value) using the reference counter 204. Where more than one thread 202 and 206 of the process references the object (e.g., the same or shared object) ABC(.1.), as in the depicted example, it is commonly referred to as a multithreaded process. It is appreciated, for simplicity of the discussion, that only two threads of a process and a single object and associated reference counter are being illustrated. However, any number of processes, threads, objects and/or reference counters may be employed.

To ensure that the reference counter 204 is properly updated during access by a thread 202 and 206, a locking mechanism may be employed to protect the reference counter 204 during a counter update (i.e., an increase or decrease to the count value). Implementation of a locking mechanism, in which a lock (e.g., a semaphore) is employed, is particularly useful where threads 202 and 206 of a multithreaded process request access to the same (shared) object ABC(.1.).

In one such embodiment of a locking mechanism, a thread accessing the object ABC(.1.) provides a lock instruction, which notifies other threads (threads other than 202 and 206) that the object ABC(.1.) is in use and should not be accessed. Some types of locks allow shared objects ABC(.1.) to be shared by many processes concurrently (e.g. a shared lock), while other types of locks prevent any type of lock from being granted on the same object ABC(.1.). It is appreciated that any time of well-known lock may be used, and that the disclosure is not limited to the described locking mechanisms.

Without a locking mechanism, the reference counter 204 may be updated by one thread 202 when another thread 206 is already processing the object ABC(.1.). In one example, failure to implement a lock results in a reference counter 204 update occurring in which the referenced object ABC(.1.) is prematurely released from memory while a thread is still processing the object ABC(.1.). In another example, the referenced object ABC(.1.) may not be released from memory after a thread has completed processing of the object ABC(.1.). In the former case, data processing may not be completed prior to release of the object ABC(.1.), whereas, in the latter case, the object ABC(.1.) continues to utilize space in memory even though data processing has been completed. Thus, application of the locking mechanism is imperative to ensure successful processing.

FIG. 2B illustrates an example of a multithreaded process in which main thread 202 and first thread 206 reference data (e.g., object ABC(.1.)) allocated in memory. Each reference to the object by a thread causes the reference counter 204 to be updated (e.g., increased or decreased). For example, when main thread 202 references the object ABC(.1.), the object ABC(.1.) is accessed from memory and a processing entity, such as application server 106A or 106N (FIG. 1), operates on the object ABC(.1.). To prevent other threads from accessing the same object ABC(.1.) at the same time, the afore-mentioned locking mechanism may be employed.

In the example, main thread 202 includes variables (var) ‘a,’ ‘b’ and ‘c,’ each of which reference (point to) the object ABC(.1.). As a variable references the object ABC(.1.), the reference counter 204 is increased (inc). As a variable goes out of scope (e.g., the variable is implicitly or explicitly de-allocated, or is no longer referenced by any other variable in subsequent execution), the reference counter 204 is decreased (dec).

Main thread 202 first references object ABC(.1.) with variable ‘a.’ As a result of the reference by main thread 202, the reference counter 204 is increased from an initial zero value to a count value of ‘1.’ The variable ‘a’ is then passed at 210 by the main thread 202 into the function runTask{(foo(a)}, which initiates first thread 206. The reference from first thread 206 to object ABC(.1.) with variable ‘aa’ causes the reference counter 204 to increase the reference count to a count value of ‘2.’

At this stage, multiple threads (i.e., main thread 202 and first thread 206) are being executed and any reference to the object ABC(.1.) updates the reference counter 204 of the object ABC(.1.). For example, reference by variables ‘b’ and ‘c’ of the main thread 202 to the object ABC(.1.) respectively cause the reference counter 204 to be increased to a count value of ‘4’ and ‘6.’. As variables ‘b’ and ‘c’ complete access to the object ABC(.1.), each variable goes out of scope (“//b is dead” and “//c is dead”) and is no longer useable. This results in each variable no longer referencing the object ABC(.1.), which thereby decreases the count value (in each instance) of the reference counter 204 to a count value of ‘5.’ In one embodiment, when variable ‘a’ references a new object ABC(.20.), the reference counter 204 associated with the object ABC(.1.) is decreased since the reference to object ABC(.1.) is out of scope (“//a is redefined”).

Similarly, first thread 206 includes variables (var) ‘aa,’ ‘bb,’ ‘cc,’ ‘dd,’ ‘x,’ ‘y,’ ‘z’ and ‘u’ that access the object ABC(.1.). As a variable references the object ABC(.1.), the reference counter 204 is increased. As a variable goes out of scope, the reference counter 204 is decreased. For example, when variable ‘dd’ references the object ABC(.1.), the reference counter 204 is increased to a count value of 6, whereas when variable ‘bb’ goes out of scope the reference count 204 is decreased since variable ‘bb’ goes out of scope (“//bb is dead”). When the last variable, in this example variable ‘u,’ goes out of scope, the count value of the reference counter 204 is decreased to a zero value, and the object ABC(.1.) is released.

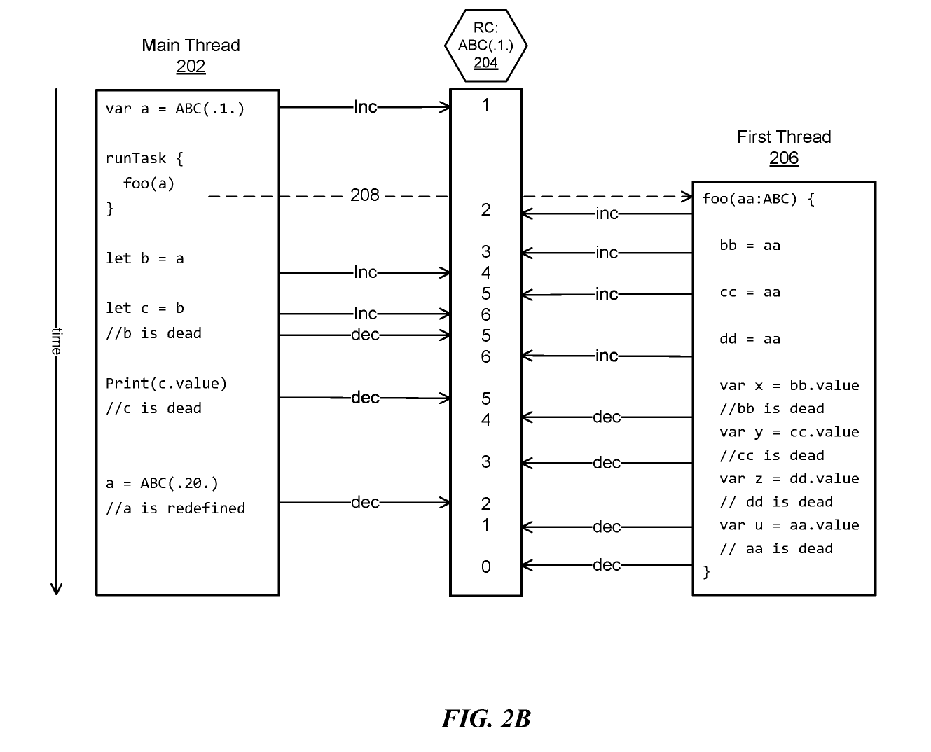

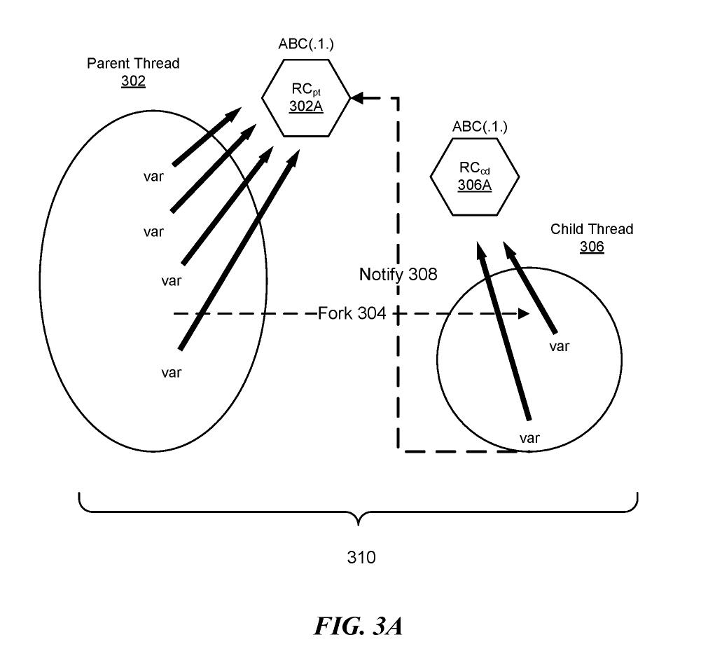

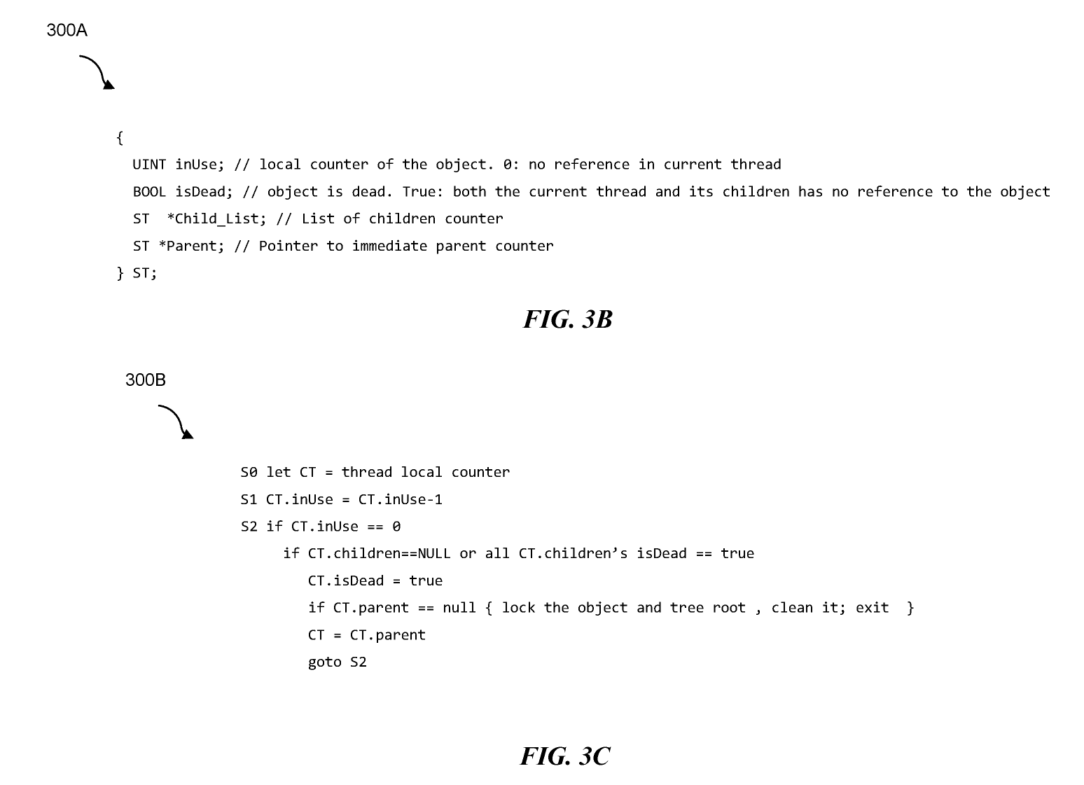

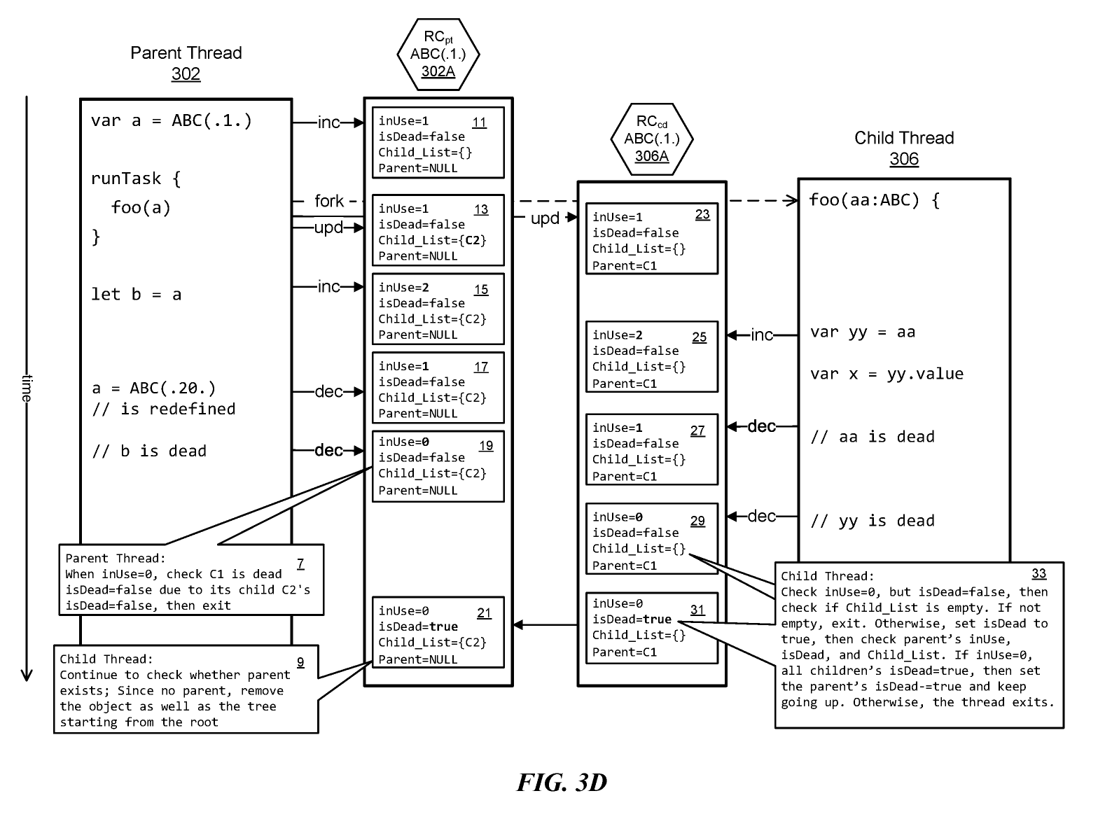

FIGS. 3A and 3D illustrate an example of threads referencing data in a memory management system in accordance with an embodiment of the disclosure. FIGS. 3C and 3B an example hierarchical counter data structure and call flow in accordance with FIGS. 3A and 3D.

While the conventional method of referencing data in memory has many benefits, each time an object stored in memory is referenced, a lock instruction is employed by the system. As the number of references to the object increases, a significant amount overhead is also generated. That is, as the number of references increases, the number of lock instructions associated with the reference also increases.

FIG. 3A illustrates an example overview of two threads of a process referencing data stored in memory. Parent thread 302 and child thread 306 of a process, similar to the embodiment of FIG. 2A, have variables (var) that reference (or point to) data that is allocated to a particular space in memory and for which a reference counter tracks the number of references being made. However, unlike the conventional method, the memory management system 312 of FIG. 3A employs two reference counters RCₚₜ 302A and RC_{cd} 308, where each reference counter includes a hierarchical counter data structure as explained in detail below.

In one embodiment of the memory management system 312, a parent thread counter RCₚₜ 302A is created when the object ABC(.1.) is allocated to memory. The parent thread counter RCₚₜ 302A tracks references from parent thread 302 to the object ABC(.1.) using a hierarchical counter data structure (discussed with reference to FIG. 3B) that keeps track of (1) the number of references in the thread (in this example, 4 variables make reference) made to the object ABC(.1.) from parent thread 302, (2) the state of the parent thread 302 as active or inactive (i.e. processing or completed processing), (3) a list of children counters (in this example, to child thread counter 306A) and (4) a pointer to any parent threads (in this example, the parent thread is the root thread and maintains a NULL or empty value.

A child thread counter RC_{cd} 308 is created when a parent thread 302 passes (forks) 304 a reference to the object ABC(.1.) to a child thread 306. Similar to the parent thread counter RCₚₜ 302A, the child thread counter RC_{cd} 306A tracks references from child thread 306 to the object ABC(.1.) using a hierarchical counter data structure. For example, the number of references by the child thread 306 is two (since two variables reference the object, as represented by two dark arrows), the state of child thread 306 is active or inactive, the list of children counters is empty since no children of the child thread counter 306A exists, and the pointer points back to the parent thread counter 302A (since parent thread 206 passed a reference to the object).

Accordingly, the parent thread counter RCₚₜ 302A tracks initiation of a thread (first reference) and exiting (going out of scope, or last reference) of a thread. In one embodiment, unlike the embodiment of FIG. 2A, references (demonstrated by dark arrows) made to the reference counters RCₚₜ 302A and RC_{cd} 308 do not employ the afore-mentioned locking mechanism. Rather, the reference counters RCₚₜ 302A and RC_{cd} 308 operate in a lock-free manner (i.e., without locking).

In one embodiment, each of the parent thread 302 and the child thread 306 initiate parent thread counter RCₚₜ 302A and child thread counter RC_{cd} 306A, respectively, that assumes reference counting operations for the object ABC(.1.). For example, when the parent thread 302 or child thread 306 references the object ABC(.1.), the associated thread counter RCₚₜ 302A and RC_{cd} 306A is updated (e.g., one or more elements of the hierarchical counter data structure is updated or modified) as opposed to the global reference counter RCG 304.

In one embodiment, the parent thread counter RCₚₜ 302A and the child thread counter RC_{cd} 306A are separate counters that are individually responsible for tracking references from one of parent thread 302 and child thread 306, respectively.

In one other embodiment, a parent thread 302 is dependent upon a child thread 306 in order to complete processing. That is, a parent thread 302 may not complete processing until each of its children threads have completed processing. In one non-limiting example, for a child thread 306 to notify 308 the parent thread it has completed processing, all references to the object ABC(.1.) must be completed (the counter has a zero value), a list of child threads for the child thread 306 must be empty (indicating no child threads exist) or all child threads of child thread 306 are inactive (i.e., completed processing).

In another embodiment, references made to the parent and child counters RCₚₜ 302A and RC_{cd} 306A operate in a lock-free manner. An object is considered lock-free if it guarantees that in a system with multiple threads attempting to perform operations on the object, some thread will complete an operation successfully in a finite number of system steps even with the possibility of arbitrary thread delays, provided that not all threads are delayed indefinitely (i.e., some thread completes operation).

By virtue of the lock-free operation, a lock instruction is not required in order to update the respective thread counter RCₚₜ 302A and RC_{cd} 306A, thereby saving a significant amount of overhead. That is, by implementation of a lock-free counting mechanism, problems associated with locking, including performance bottlenecks, susceptibility to delays and failures, design complications and, in real-time systems, priority inversion, may be avoided.

FIG. 3B illustrates a hierarchical counter data structure for a counter in accordance with FIG. 3A. It is appreciated in the discussion that follows that the disclosed member elements are non-limiting, and any number of different member elements may be added or removed.

When an object ABC(.1.) is initially created by a single thread (e.g., parent thread RC 302), a local structure (ST) is also created as part of the parent thread counter RCₚₜ 302A. Each structure (herein referred to as a hierarchical counter data structure 300A) includes member elements that are initialized, as described below.

When a child thread RC 306 is created and passed (forked) a reference of the object ABC(.1.) by the parent thread RCₚₜ 302A, the child thread creates a separate a hierarchical counter data structure 300A for the child thread counter RC_{cd} 306A, for example, named CT Child, where each member element is also initialized.

The hierarchical counter data structure 300A includes, for example, member elements of a count value, a state of the object, a list of child counters and a pointer. Applying the member elements illustrated in FIG. 3B, the count value (inUse) is responsible for counting the number of references being made to an object by a particular counter. For example, if the count value is zero, no references are being made by the corresponding thread.

The state (isDead) of the object determines whether an object is active (alive) or inactive (dead). For example, when the state is TRUE (isDead=TRUE), the object is no longer being referenced and is dead. Thus, for a state to be TRUE, both the current thread and children thread may not have any references to the object.

The list of child counters (Child_List) member element is responsible for listing each of children thread counter(s) for a parent thread. For example, if a parent thread 302 has two children, each with their own counter, the list of child counters in the parent thread will indicate (list) the two counters as part of its hierarchical counter data structure.

The pointer, which points to an immediate parent thread counter, is also a member element. Following the example of a parent thread having two child threads, each of the child thread counters would include a pointer that points back to the immediate (in this case the same) parent.

FIG. 3C illustrates an example call flow that implements the hierarchical counter data structure of FIG. 3B. The call flow 300B is an example of an updating sequence for removing references (dereference). The call flow may be implemented, in one non-limiting embodiment, by an application server 106N (FIG. 1). However, it is appreciated that implementation is not limited to the application server, and that any of the various components depicted in FIG.1 may be responsible for processing the disclosed call flow.

In the example embodiment, when adding a reference, a local thread will update the corresponding local counter (e.g., child thread 306 updates child thread counter RC_{cd} 306A such that inUse=inUse+1). As the local counter is updated or modified by the local thread in currently in use, there is no data race when reading/writing to the local counter by other threads. When removing a reference, a more particular process is implemented, as follows.

The call flow 300B demonstrates an example where CT is set as a thread counter (thread local counter) with “inUse” indicating a counter value for the number of references being made to an object. When a reference goes out of scope (no longer exists), the thread counter CT is decreased by “1” (inUse−1). Next, each of the member elements are checked to determine whether they satisfy various conditions. In the example of call flow 300B, when the thread counter count value is zero, the server 106N determines whether a list of child counter for thread counter CT (CT.children) is NULL or all child threads in the list of child threads are inactive. The server 106N also determines whether the state of the thread counter CT is TRUE (inactive) and the pointer is empty (CT.parent=NULL indicating no parent threads exist). The server 106N also verifies that the pointer does not refer to any parent thread (i.e., the thread is a parent=NULL). If these conditions are satisfied, the object is locked and cleaned and the process exits. Otherwise, the process continues until reaching the parent thread (root thread).

By virtue of the above-described call flow, data race is eliminated when removing a reference to an object. Although the “isDead” value may be modified (flipped) from one state to another (i.e., FALSE to TRUE) by multiple threads, the state is flipped unidirectional from FALSE to TRUE, if at all. Additionally, updating the Child_List is dependent upon the value of inUse. That is, when inUse is “0,” the corresponding thread count will not be modified, but may be read by other threads. Otherwise, when inUse is not “0,” only the current thread may modify it by adding children to the Child_List. Moreover, in one embodiment, the member element “pointer” (indicative of a parent thread) is read-only after creation (i.e., after setting the value during initialization of the counter).

FIG. 3D illustrates an example of a multithreaded process in which parent thread 302 and child thread 306 reference data (e.g., object ABC(.1.)) allocated in memory. When the object ABC(.1.) is initially created, the parent thread counter RCₚₜ 302A is also created. During the initialization period, the member elements in the hierarchical counter data structure 300A (also represented in FIG. 3D by items 11, 13, 15 . . . 29 and 31) are set to initial values. For example, inUse=0, isDead=FALSE, Child_List={ } and Parent=NULL. Each time a variable (e.g. ‘var a’) of the parent thread 302 references the object ABC(.1.), the hierarchical counter data structure 300A of the parent thread counter RCₚₜ 302A is sent a command (e.g., an increment or ‘inc’) to be updated (e.g., modify one or more member elements in the hierarchical counter data structure 300A). In one embodiment, the increment occurs upon a first reference to the object.

For example, when parent thread 302 references the object (var a=ABC(.1.)), the parent thread counter RCₚₜ 302A is increased from a zero value to a count value of ‘1’ (inUse=1 at 11).

Similarly, and after parent thread 302 passes (forks) “var a” to child thread 306 via runTask{foo(a)}, the of child thread counter RC_{cd} 306A is created and initialized, and the child thread counter RC_{cd} 306A is increased from an initial value of zero to a value of “1” (inUse=1 at 23). Additionally, since the child thread 306 has a parent thread 302, the hierarchical counter data structure 300A is also updated to modify the pointer to point to parent thread counter RCₚₜ 302A (identified as “C1” in the figure).

For example, when a variable (var yy=aa)) of the child thread 306 references the object ABC(.1.), the child thread counter RC_{cd} 306A is increased from a count value of ‘1’ to a count value of ‘2’ (inUse=2 at 25).

Subsequent references to the object ABC(.1.) also update (e.g., increase or decrease) a respective one of the parent thread counter and child thread counter RCₚₜ 302A and RC_{cd} 306A. Likewise, when an object is dereferenced by a thread, the respective parent and thread counter RCₚₜ 302A and RC_{cd} 306A is decremented (‘dec’) by a count of ‘1.’

It is also appreciated that references (including subsequent references) to the object ABC(.1.) may also initiate changes to other member elements in the hierarchical counter data structure 300A. For example, when the parent thread 302 passes a reference to the object ABC(.1.), an update message is sent to the parent thread counter RCₚₜ 302A to modify the list of children in the hierarchical counter data structure 300A (in this case, item 13) to include the newly created child thread 306 (Child_List={C2}, where C2 refers to the child thread counter).

As noted above, in one embodiment, references to the parent and child thread counters RCₚₜ 302A and RC_{cd} 306A are performed in a lock-free manner (i.e., without locking).

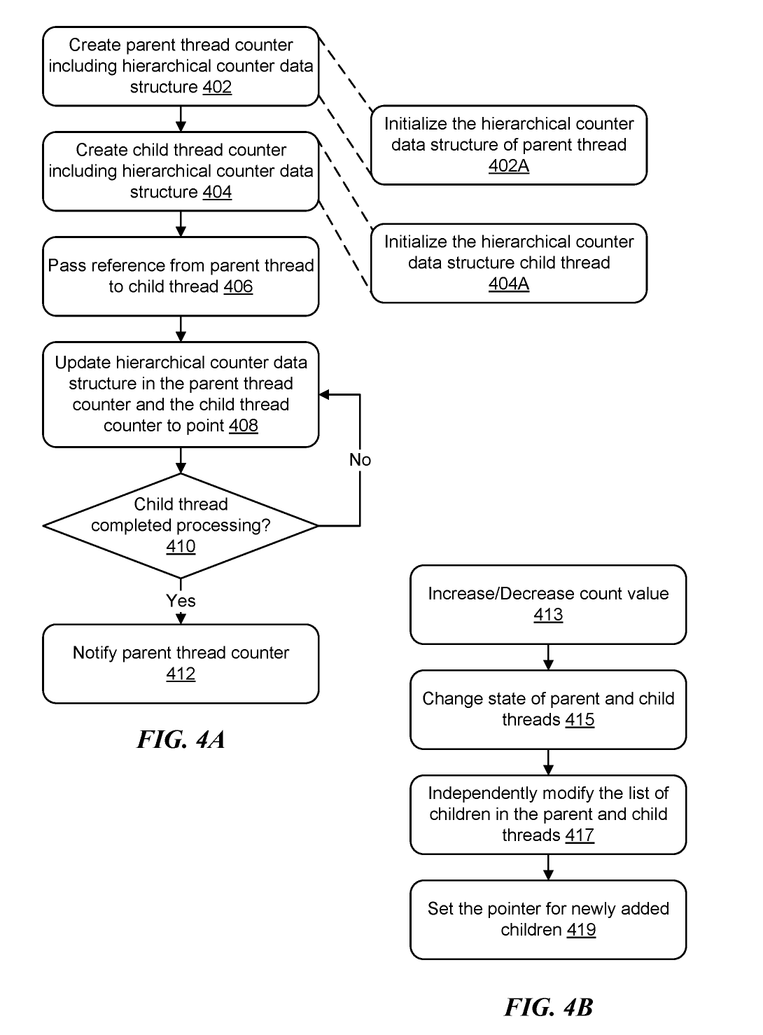

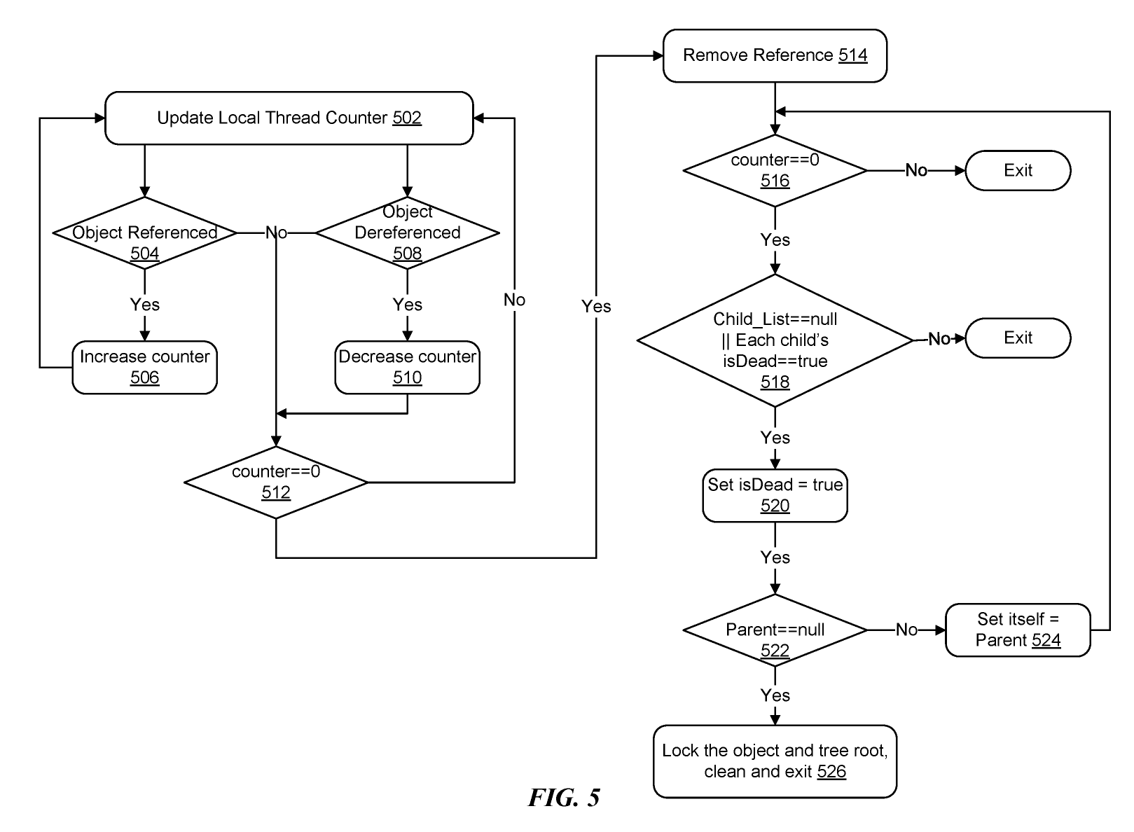

In another embodiment, when the child thread 306 references the object ABC(.1.) such that the count value is zero, the child thread 306 is checked to determine whether processing has been completed. For example, when the last variable (var yy) in the child thread 306 goes out of scope, the child thread counter RC_{cd} 306A is decreased to a count value of zero (inUse=0) and the child thread is checked to determine with processing has been completed, as described below with reference to FIGS. 4A-4C and 5.

If the child thread 306 has completed processing, then the parent thread 302 is checked to determine the status of processing. Similar to the child thread counter RC_{cd} 306A, the parent thread counter RCₚₜ 302A is updated to reflect removal of references from the parent thread 302 to the object. For example, when parent thread 302 redefines variable ‘a’ to reference object ABC(.2) (var a=ABC(.2.)), the parent thread counter RCₚₜ 302A is decreased by a count of 1. In this example, the count value in the hierarchical counter data structure 300A (in this case item 19) drops to zero (inUse=0). Once the count value has dropped to zero, the parent thread 302 is checked to determine whether processing has been completed, as described below with reference to FIGS. 4A-4C and 5. If processing has been completed, the object ABC(.1.) may be released from memory.

In one embodiment, a flag is employed to indicate whether the object has ABC(.1.) been released from memory (deallocated). Since multiple threads may try to release the same object at the same time, the flag may be employed to prevent such action. For example, the flag may indicate that an object is currently being processed by another thread. To ensure the flag cannot be changed during processing, a locking mechanism may be employed during object removal (deallocation), as opposed to during reference counting.

FIGS. 4A-4C illustrate flow diagrams of reference counting in accordance with the embodiments disclosed in FIGS. 1 and 3A-3D. The methodology disclosed in the flow diagrams that follow may be implemented, in one non-limiting embodiment, by an application server 106N (FIG. 1). The application server 106N may be responsible for executing threads of a process that access a distributed data store containing objects for processing. However, it is appreciated that implementation is not limited to the application server, and that any of the various components depicted in FIG.1 may be responsible for processing the disclosed methodology.

At 402, when an object ABC(.1.) is created and allocated to memory, a parent thread counter RCₚₜ 302A is set to count the number of threads referencing (pointing to) the object ABC(.1.). The parent thread counter RCₚₜ 302A, as explained above, includes a hierarchical counter data structure 300A that tracks references being made by the threads to the object ABC(.1.). The member elements of the parent thread counter RCₚₜ 302A is updated (e.g., modifications to count value, state, child list and pointer) depending on the particular command being issued by the thread. In one embodiment, no locking mechanism is employed to protect updates to the parent thread counter RCₚₜ 302A.

In one embodiment, when the parent thread 302 first references the object ABC(.1.), the parent thread counter RCₚₜ 302A is initiated. Initialization of the parent thread counter RCₚₜ 302A includes, for example, initializing the hierarchical counter data structure 300A at 402A, described below with reference to FIG. 4B. Subsequently, the parent thread counter RCₚₜ 302A tracks references made to and removed from the object ABC(.1.).

At 404, a child thread counter RC_{cd} 306A of child thread 306 is crated when the parent thread 302 passed (forks) the reference to the object ABC(.1.) at 406. For example, when the variable ‘a’ is passed by the parent thread 302 into the function runTask{(foo(a)}, the child thread 306 is initiated.

The child thread counter RC_{cd} 306A also includes a hierarchical counter data structure 300A. The hierarchical counter data structure 300A is initialized at 404A in a manner similar to parent thread counter RCₚₜ 302A, although the initial values may differ, as explained below with reference to FIG. 4B. Subsequently, the child thread counter RC_{cd} 306A tracks references made to and removed from the object ABC(.1.).

The tracked references at both the parent thread counter RCₚₜ 302A and the child thread counter RC_{cd} 306A cause the hierarchical counter data structure 300A of the respective counters to be updated such that the parent thread counter RCₚₜ 302A references the child thread counter RC_{cd} 306A and the child thread counter RC_{cd} 306A points to the parent thread counter RCₚₜ 302A at 408. In one embodiment, the reference from the parent thread counter RCₚₜ 302A to the child thread counter RC_{cd} 306A and the child thread counter RC_{cd} 306A pointing to the parent thread counter RCₚₜ 302A forms a hierarchical structure, which may be expressed as a directed tree graph, where the parent thread counter RCₚₜ 302A is a root node and the child thread counter RC_{cd} 306A is a leaf node of the root node. As additional references and pointers are formed, the directed tree graph scales to further form the hierarchal structure.

At 410, the server 106N determines whether the child thread 306 has completed processing of the object ABC(.1.). If processing has not been completed, then the procedure returns to 408. Otherwise, the parent thread counter RCₚₜ 302A is notified that the child thread 306 has completed processing at 412.

FIG. 4B illustrates an example flow diagram of updating the hierarchical counter data structure in accordance with FIGS. 3A and 4A. When a parent thread counter RCₚₜ 302A is first created, the hierarchical counter data structure 300A is initialized. In one embodiment, the hierarchical counter data structure 300A is initialized by setting a count value to an initial value of 1, a state of the parent thread to active, a list of children to empty and a pointer to empty. A child thread counter RC_{cd} 306A, when first created, is similarly initialized. However, the hierarchical counter data structure 300A is initialized by setting a child count value to an initial value of 1, a state of the parent thread to active, a list of children to empty and a pointer to the parent thread counter RCₚₜ 302A.

After initialization, the hierarchical counter data structure 300A may be updated as follows. At 413, the update increases (reference added) or decreases (reference removed) one of the parent or child reference counters RCₚₜ 302A and RC_{cd} 306A when the object ABC(.1.) is referenced or dereferenced by the parent thread 302 and child thread 306.

At 415, the update changes the state of the parent and/or child threads 302 and 306. The update to change the state includes changing the state from active to inactive. For example, when a variable (e.g., var aa) completes processing of the object ABC(.1.), the state (isDead) of the child counter RC_{cd} 306A goes from FALSE (active) to TRUE (inactive). In one embodiment, the change of state goes in one direction—from active to inactive.

At 417, the update independently modifies the list of children in the hierarchical counter data structure 300A of the parent thread 302 and/or the child thread 306 to add or remove children counters. For example, when the parent thread 302 passes reference to the object and forks a child thread 306, the hierarchical data structure 300A of the parent thread counter RCₚₜ 302A is updated to indicate that the child thread counter RC_{cd} 306A is a child in the list of children.

Similar to a parent thread counters listing children, child thread counters similarly point to parent thread counters. At 419, when a child thread counter RC_{cd} 306A is created, the hierarchal counter data structure 300A is updated to point to the immediate (i.e., direct) parent thread counter RCₚₜ 302A.

FIG. 5 illustrates one embodiment of a flow diagram for a local thread counter in accordance with FIGS. 3A-3B, 3D and 4A-4B. In particular, the flow diagram demonstrates the methodology of updating a local thread counter, such as parent and child thread counters RCₚₜ 302A and RC_{cd} 306A.

In general, when an object is allocated into memory, the hierarchical counter data structure 300A (also represented in FIG. 3D by items 11, 13, 15 . . . 29 and 31) in the parent thread 302 is initialized. When the parent thread 302 forks a new thread (e.g., child thread 306) that references the variable from the parent thread 302, another (new) hierarchical counter data structure 300A is initialized by the forked child thread 306. Once each of the parent and child thread counters (local counters) RCₚₜ 302A and RC_{cd} 306A have been established, references are tracked by updating the respective local thread counter. When a local thread counter reaches a value of “0” (a zero value), no more references to the object remain in the current thread.

For example, at 502 an update to a local thread counter is initiated by reference to an object or dereference to an object. If an object is being referenced (added) by a thread at 504, then the local thread counter is increased at 506. If the object is being dereferenced (removed) by a thread at 508, then the local thread counter is decreased at 510. In either case, if the count value of the local thread counter does not equal zero, then the process returns to 502. Otherwise, if the count value of the local thread counter is equal to zero, then processing of the object has been completed and the procedure continues to removing the reference at 514.

Once the count value (inUse) reduces to a zero value, as determined at 516, the value of the state (isDead) in the hierarchical counter data structure 300A is checked at 518. For example, the list of children (Child_List) is checked to see whether the list is empty or any children are listed. If the list of children is not empty (Child_List≠NULL) or all of the listed children are not inactive (isDead≠TRUE for all listed children), then the procedure exits. Stated differently, if the state (isDead)=FALSE (active), since at least one child thread has a state value “isDead”=FALSE, the child thread 306 exits. Otherwise, if the conditions are satisfied, the procedure moves to 520 to set the state of the local thread counter to inactive (isDead=TRUE). For example, when “isDead” changes to TRUE (e.g., the thread has completed processing and goes out of scope).

At 522, after it is determined that the local thread counter has completed processing, the pointer value in the hierarchical counter data structure 300A is checked. If no pointer to a parent thread exists (e.g., pointer=NULL; the thread is a root parent thread since there is pointer to a parent thread), then the root parent thread (in the example of FIG. 3D, parent thread 302) locks and removes the referenced object at 526. Otherwise, at 524, the thread will continue to traverse upwards through the parent threads, while setting the pointer, until reaching the root parent thread. This traversal, in one embodiment, may be implemented as a directed tree graph, where the root parent node is the root node of the tree, and the children nodes are leaves in the tree.

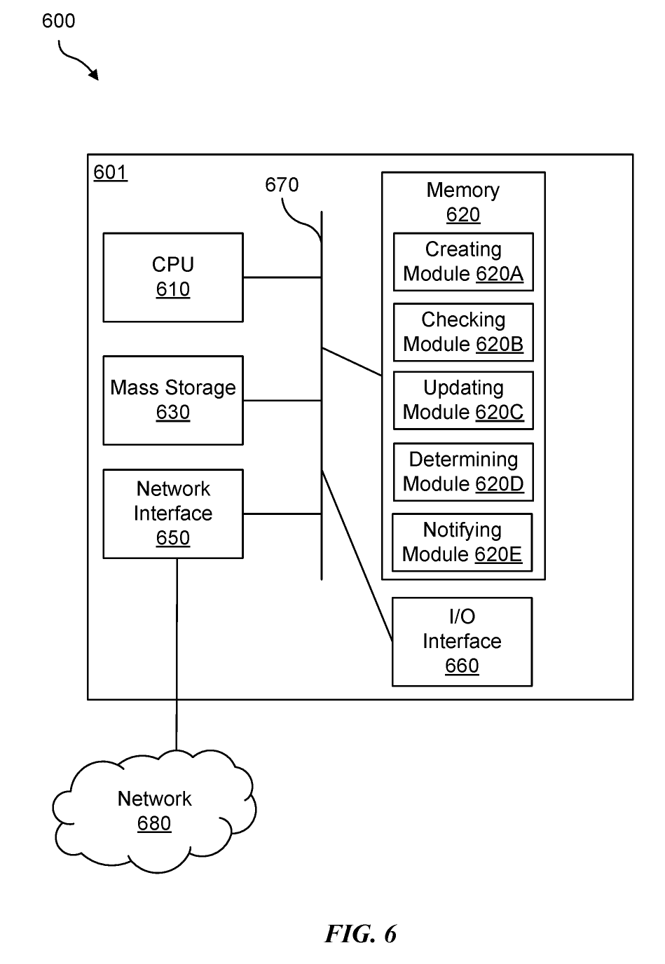

FIG. 6 is a block diagram of a network device 600 that can be used to implement various embodiments. Specific network devices may utilize all of the components shown, or only a subset of the components, and levels of integration may vary from device to device. Furthermore, the network device 600 may contain multiple instances of a component, such as multiple processing units, processors, memories, transmitters, receivers, etc. The network device 600 may comprise a processing unit 601 equipped with one or more input/output devices, such as network interfaces, storage interfaces, and the like. The processing unit 601 may include a central processing unit (CPU) 610, a memory 620, a mass storage device 630, and an I/O interface 660 connected to a bus 670. The bus 670 may be one or more of any type of several bus architectures including a memory bus or memory controller, a peripheral bus or the like.

The CPU 610 may comprise any type of electronic data processor. The memory 620 may comprise any type of system memory such as static random access memory (SRAM), dynamic random access memory (DRAM), synchronous DRAM (SDRAM), read-only memory (ROM), a combination thereof, or the like. In an embodiment, the memory 620 may include ROM for use at boot-up, and DRAM for program and data storage for use while executing programs. In embodiments, the memory 620 is non-transitory. In one embodiment, the memory 620 includes a creating module 620A to create parent and child thread counters corresponding parent and child threads, checking module 620B to check local thread counters to determine the status of the member elements, an updating module 620C to update the hierarchical counter data structure in the local thread counters, a determining module 620D to determine whether processing has been completed and a notifying module 620E to notify parent threads when child threads have completed processing.

The mass storage device 630 may comprise any type of storage device configured to store data, programs, and other information and to make the data, programs, and other information accessible via the bus 670. The mass storage device 630 may comprise, for example, one or more of a solid state drive, hard disk drive, a magnetic disk drive, an optical disk drive, or the like.

The processing unit 601 also includes one or more network interfaces 650, which may comprise wired links, such as an Ethernet cable or the like, and/or wireless links to access nodes or one or more networks 680. The network interface 650 allows the processing unit 601 to communicate with remote units via the networks 680. For example, the network interface 650 may provide wireless communication via one or more transmitters/transmit antennas and one or more receivers/receive antennas. In an embodiment, the processing unit 601 is coupled to a local-area network or a wide-area network for data processing and communications with remote devices, such as other processing units, the Internet, remote storage facilities, or the like.

It is understood that the present subject matter may be embodied in many different forms and should not be construed as being limited to the embodiments set forth herein. Rather, these embodiments are provided so that this subject matter will be thorough and complete and will fully convey the disclosure to those skilled in the art. Indeed, the subject matter is intended to cover alternatives, modifications and equivalents of these embodiments, which are included within the scope and spirit of the subject matter as defined by the appended claims. Furthermore, in the following detailed description of the present subject matter, numerous specific details are set forth in order to provide a thorough understanding of the present subject matter. However, it will be clear to those of ordinary skill in the art that the present subject matter may be practiced without such specific details.

In accordance with various embodiments of the present disclosure, the methods described herein may be implemented using a hardware computer system that executes software programs. Further, in a non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

One or more non-limiting advantages of the disclosed technology is to pre-allocated multiple counters, utilize object allocation and thread forking and recycling counter data structure from a root node. Additionally, all the counters may have the same data structure, which helps to optimize the performance, e.g. pre-allocate a bunch of counters and put them into a free list. When allocating new objects or thread forking, the counter can be requested from the free list. Given the tree structure (hierarchical structure) of the counters, when the object is freed, the counter data structures can be recycled from the root.

Additionally, although the disclosure generally refers to garbage collection, the system is not limited to such an embodiment. The methodology may also be employed in any system in which a lock may be employed or for which a resource is requested and/or used by multiple clients. That is, the above-described methodology may also be implemented in systems outside of garbage collection, and for which the system wants to ensure that all users of the resource have completed their use and the resource can be released.

The computer-readable non-transitory media includes all types of computer readable media, including magnetic storage media, optical storage media, and solid state storage media and specifically excludes signals. It should be understood that the software can be installed in and sold with the device. Alternatively the software can be obtained and loaded into the device, including obtaining the software via a disc medium or from any manner of network or distribution system, including, for example, from a server owned by the software creator or from a server not owned but used by the software creator. The software can be stored on a server for distribution over the Internet, for example.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

For purposes of this document, each process associated with the disclosed technology may be performed continuously and by one or more computing devices. Each step in a process may be performed by the same or different computing devices as those used in other steps, and each step need not necessarily be performed by a single computing device.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method for reference counting, comprising:
creating a parent thread counter corresponding to an object referenced by a parent thread, the parent thread counter comprising a hierarchical counter data structure;
creating a child thread counter of a child thread including the hierarchical counter data structure and passing the reference to the object from the parent thread to the child thread;
updating the hierarchical counter data structure in the parent thread counter to reference the child thread counter and in the child thread counter to point to the parent thread counter; and
notifying the parent thread counter when the child thread has completed processing.

2. The computer-implemented method of claim 1, wherein
creating the parent thread counter includes initializing the hierarchical counter data structure to set a parent count value to an initial value of 1, a state of the parent thread to active, a list of children to empty and a pointer to empty, and
creating the child thread counter includes initializing the hierarchical counter data structure to set a child count value to an initial value of 1, a state of the parent thread to active, a list of children to empty and a pointer to the parent thread counter.

3. The computer-implemented method of claim 2, wherein updating the hierarchical counter data structure comprises:
increasing the parent count value of the parent thread counter when the parent thread adds a reference to the object and decreasing the parent count value of the parent thread counter when the parent thread removes the reference to the object; and
increasing the child count value of the child reference counter when the child thread adds a reference to the object and decreasing the child count value of the child reference counter when the child thread removes the reference to the object.

4. The computer-implemented method of claim 3, further comprising:
changing the state of the parent thread and the child thread from active to inactive upon completion of processing;
independently modifying the list of children in the parent thread and the child thread to add or remove children counters; and
setting the pointer for newly added children to point to a direct parent counter.

5. The computer-implemented method according to 3, wherein removing the reference to the object comprises:
determining whether the child thread counter has completed processing based on the child count value;
checking the child thread counter for the list of children; and
in response to the child count value of the child thread counter being zero, the list of children of the child thread counter being empty or all of the child threads listed in the list of children for the child thread being inactive and the state of the child thread being inactive, removing the reference to the object.

6. The computer-implemented method of claim 5, further comprising:
determining whether the parent thread counter has completed processing based on the parent count value;
checking the pointer in the parent thread; and
releasing the object from the memory in response to the pointer being empty and the state of the parent thread being inactive.

7. The computer-implemented method of claim 1, wherein the hierarchical counter data structure includes a count value to count a number of references to the object, a variable indicating a state of the object as active or inactive, a list of child counters and a pointer to point to a parent counter.

8. The computer-implemented method of claim 7, wherein
the count value indicating the number of references to the object is independently modified by one of the parent thread and the child thread;
the state is changed from an active state to an inactive state;
the list of child counters identifies individual children counters for a corresponding one of the threads; and
the pointer is set when initially creating one of the thread counters.

9. The computer-implemented method of claim 1, wherein the parent thread counter and the child thread counter employ a lock-free reference count.

10. An device for reference counting, comprising:
a non-transitory memory storage comprising instructions; and
one or more processors in communication with the memory, wherein the one or more processors execute the instructions to perform operations comprising:
creating a parent thread counter corresponding to an object referenced by a parent thread, the parent thread counter comprising a hierarchical counter data structure;
creating a child thread counter of a child thread including the hierarchical counter data structure and passing the reference to the object from the parent thread to the child thread;
updating the hierarchical counter data structure, without locking, in the parent thread counter to reference the child thread counter and in the child thread counter to point to the parent thread counter; and
notifying the parent thread counter when the child thread has completed processing.

11. The device of claim 10, wherein
creating the parent thread counter includes initializing the hierarchical counter data structure to set a parent count value to an initial value of 1, a state of the parent thread to active, a list of children to empty and a pointer to empty, and
creating the child thread counter includes initializing the hierarchical counter data structure to set a child count value to an initial value of 1, a state of the parent thread to active, a list of children to empty and a pointer to the parent thread counter.

12. The device of claim 11, wherein updating the hierarchical counter data structure comprises:
increasing the parent count value of the parent thread counter when the parent thread adds a reference to the object and decreasing the parent count value of the parent thread counter when the parent thread removes the reference to the object; and
increasing the child count value of the child reference counter when the child thread adds a reference to the object and decreasing the child count value of the child reference counter when the child thread removes the reference to the object.

13. The device of claim 12, further comprising:
changing the state of the parent thread and the child thread from active to inactive upon completion of processing;
independently modifying the list of children in the parent thread and the child thread to add or remove children counters; and
setting the pointer for newly added children to point to a direct parent counter.

14. The device according to 12, wherein removing the reference to the object comprises:
determining whether the child thread counter has completed processing based on the child count value;
checking the child thread counter for the list of children; and
in response to the child count value of the child thread counter being zero, the list of children of the child thread counter being empty or all of the child threads listed in the list of children for the child thread being inactive and the state of the child thread being inactive, removing the reference to the object.

15. The device of claim 14, further comprising:
determining whether the parent thread counter has completed processing based on the parent count value;
checking the pointer in the parent thread; and
releasing the object from the memory in response to the pointer being empty and the state of the parent thread being inactive.

16. A non-transitory computer-readable medium storing computer instructions for reference counting, that when executed by one or more processors, perform the steps of:
creating a parent thread counter corresponding to an object referenced by a parent thread, the parent thread counter comprising a hierarchical counter data structure;
creating a child thread counter of a child thread including the hierarchical counter data structure and passing the reference to the object from the parent thread to the child thread;
updating the hierarchical counter data structure in the parent thread counter to reference the child thread counter and in the child thread counter to point to the parent thread counter; and
notifying the parent thread counter when the child thread has completed processing.

17. The non-transitory computer-readable medium of claim 16, wherein when executed by one or more processors, perform the further steps of:
creating the parent thread counter includes initializing the hierarchical counter data structure to set a parent count value to an initial value of 1, a state of the parent thread to active, a list of children to empty and a pointer to empty, and
creating the child thread counter includes initializing the hierarchical counter data structure to set a child count value to an initial value of 1, a state of the parent thread to active, a list of children to empty and a pointer to the parent thread counter.

18. The non-transitory computer-readable medium of claim 17, wherein updating the hierarchical counter data structure, when executed by one or more processors, perform the further steps of:
increasing the parent count value of the parent thread counter when the parent thread adds a reference to the object and decreasing the parent count value of the parent thread counter when the parent thread removes the reference to the object; and
increasing the child count value of the child reference counter when the child thread adds a reference to the object and decreasing the child count value of the child reference counter when the child thread removes the reference to the object.

19. The non-transitory computer-readable medium of claim 18, wherein when executed by one or more processors, perform the further steps of:
changing the state of the parent thread and the child thread from active to inactive upon completion of processing;
independently modifying the list of children in the parent thread and the child thread to add or remove children counters; and
setting the pointer for newly added children to point to a direct parent counter.

20. The non-transitory computer-readable medium according to 18, wherein removing the reference to the object when executed by one or more processors, perform the further steps of:
determining whether the child thread counter has completed processing based on the child count value;
checking the child thread counter for the list of children; and
in response to the child count value of the child thread counter being zero, the list of children of the child thread counter being empty or all of the child threads listed in the list of children for the child thread being inactive and the state of the child thread being inactive, removing the reference to the object.

21. The non-transitory computer-readable medium of claim 20, wherein when executed by one or more processors, perform the further steps of:
determining whether the parent thread counter has completed processing based on the parent count value;
checking the pointer in the parent thread; and
releasing the object from the memory in response to the pointer being empty and the state of the parent thread being inactive.

22. The non-transitory computer-readable medium of claim 16, wherein the parent thread counter and the child thread counter employ a lock-free reference count.
